(19) United States
(12) Patent Application Publication
(10) Pub. No.: US 2005/0039864 A1
(43) Pub. Date: Feb. 24, 2005

(54) Sliding door having a removable screen panel track

(76) Inventors: Edmond Arcamonte, Miami, FL (US); Angel Mestres, Miami, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 10/981,199

(22) Filed: Nov. 4, 2004

Related U.S. Application Data
(63) Continuation-in-part of application No. 10/734,341, filed on Dec. 11, 2003.
(60) Provisional application No. 60/518,455, filed on Nov. 7, 2003.

(51) Int. Cl. A47G 5/02; E06B 9/56

(52) U.S. Cl. 160/290.1

(57) ABSTRACT

A sliding door system having a removable screen panel track is disclosed. The door frame has a bottom portion, a top portion, a top sliding screen panel track extending along the top side section of the top portion; a bottom rail slot on an outer side of the bottom side section of the bottom portion and extending along the bottom side section; and a removable rail removably attached to the rail slot to form a bottom sliding screen panel track. In one design, the bottom sliding screen panel track and the top sliding screen panel track are positioned in the interior side of the door frame, and a sliding screen panel is installed between the tracks in the interior of the door system. The removable screen panel track can also be positioned at the exterior side of the door system.

### CROSS REFERENCE TO RELATED APPLICATIONS

This application claims the benefit under 35 USC 119 (e) of the provisional patent application Ser. No. 60/518,455, filed on Nov. 7, 2003, and is a continuation-in-part of patent application Ser. No. 10/734,341, filed on Dec. 11, 2003. Both prior patents are herein incorporated by reference in their entirety.

### FIELD OF THE INVENTION

The present invention relates to a sliding door system, more specifically to a sliding door system which has a removable screen panel track for selective installation of a screen panel.

### BACKGROUND OF THE INVENTION

Various window and glass doors have been developed in an effort to avoid entrance of water and structural damage that may result from high winds, as may be experienced in a hurricane. For example, as a result of the widespread destruction caused by hurricane Andrew in 1992, new standards have been proposed in certain southern Florida counties to provide stronger windows and doors to decrease the damage to building structures during severe storms. The glass used in wind resistant windows and doors is typically a laminated glass panel and includes at least one plastic reinforcing layer and one or more glass layers.

In addition to the materials, the structures of the sliding glass door assembly is very important for preventing entrance of wind and water through the sliding doors into the building, and maintaining the integrity of the sliding door. Commonly, during a severe storm high winds carrying rain push into the building through the spaces at interfaces between door panels with the door frame, particularly between the sliding door panel and the door frame, especially at the bottom. The wind forced at the spaces of the interfaces can also lift the sliding door panel, either causing distortion of the door frame structure or having the sliding door panel blown out of the door frame.

Another challenge to the sliding glass door assembly is on the sliding screen panel. Traditionally, the sliding screen panel is positioned at the exterior of a sliding door assembly. During a severe storm, the sliding screen panel sash tends to be deformed by strong winds. The whole screen panel is frequently blown away during a hurricane or tropical storm.

In addition to the structural integrity under storm condition, the exterior screen panel design also has other disadvantages. It is commonly recognized that the exterior screen panel collects dust whether in use or not, and becomes dirty easily. Furthermore, in a high rise building the exterior screen panel also affects the appearance of the glass doors, and the appearance of the whole building.

On the other hand, traditionally customers do not have options to choose to install or not install a sliding screen panel with an already manufactured sliding door system. Furthermore, the customers do not have options to choose to install the sliding screen panel at the interior or exterior of the door system.

Therefore, it is desirable to have a sliding door system which has a removable screen panel track, which can be installed based on an user's selection. Furthermore, it is also desirable to be able to install a sliding screen panel in the interior of the door system. It is further desirable to have an improved sliding door system which is resistant to storm weather condition.

### SUMMARY OF THE INVENTION

In one embodiment, the present invention provides a sliding door system which has a removable screen panel track. The sliding door system comprises: (a) a door frame to be positioned in a structure opening, the door frame having a bottom portion, a top portion and two side portions; the bottom portion having a bottom base section connected perpendicularly to a bottom side section; the top portion having a top base section connected perpendicularly to a top side section; wherein the door frame has a first sliding door panel track extending along the bottom base section, a second sliding door panel track extending along the top base section; a top sliding screen panel track extending along the top side section; a bottom rail receiving means on an outer side of the bottom side section and extending along the bottom side section; and a bottom rail removably attached to the bottom rail receiving means forming a bottom sliding screen panel track; (b) at least one fixed door panel, positioned between said top portion and bottom portion of said door frame, the fixed door panel comprising a fixed door sash and a glass panel carried in the fixed door sash; (c) at least one sliding door panel slidably positioned between the sliding door panel tracks; the sliding door panel comprising a sliding door sash and a glass panel carried in the sliding door sash, sliding door rollers extending outwardly from a bottom of the sliding door sash and engaging the first sliding door panel track; and (d) a sliding screen panel slidably positioned between the top sliding screen panel track and the bottom sliding screen panel track; the sliding screen panel comprising a sliding screen sash and a screen panel carried in the sliding screen sash. In one preferred embodiment, the bottom rail receiving means is a bottom rail slot extending along the bottom side section.

In one embodiment, the bottom side section is at an interior side of the door frame, and the bottom and top sliding screen panel tracks are at the interior side of the door frame. The sliding door system has a sliding screen panel at the interior side of the door frame.

In another embodiment, the bottom side section is at an exterior side of the door frame, and the bottom and top sliding screen panel tracks are at the exterior side of the door frame. The sliding door system has a sliding screen panel at the exterior side of the door frame.

In a further embodiment, the top sliding screen panel track is fixed on to the top side section. In an alternative embodiment, the top side section has a top rail receiving means on an outer side of the top side section and extending along the top side section; and a top rail removably attached to the top rail receiving means forming the top sliding screen panel track. The top rail receiving means can be a top rail slot.

In another embodiment, the present invention is directed to a door frame which has a removable screen panel track. The door frame comprises (a) a bottom portion having a bottom base section connected perpendicularly to a bottom side section of the door fame; a first sliding door panel track extending along the bottom base section; a bottom rail receiving means extending along the bottom side section; and a bottom rail removably attached to the bottom rail receiving means forming a bottom sliding screen panel track; (b) a top portion having a top base section connected perpendicularly to a top side section; a second sliding door panel track extending along the top base section; and a top sliding screen panel track extending along the top side section; and (c) two side portions.

In one embodiment, the bottom side section is at an interior side of the door frame, and the bottom and top sliding screen panel tracks are at the interior side of the door frame. Alternatively, the bottom side section is at an exterior side of the door frame, and the bottom and top sliding screen panel tracks are at the exterior side of the door frame.

In one embodiment, the top sliding screen panel track is fixed on to the top side section. In an alternative embodiment, the top side section has a top rail receiving means extending along the top side section; and a top rail removably attached to the top rail receiving means forming the top sliding screen panel track. In one preferred embodiment, the bottom and top rail receiving means are rail slots complementary to the bottom and top rails.

### BRIEF DESCRIPTION OF THE DRAWINGS

FIG. 1A is a schematic exterior view of one embodiment of the present invention.

FIG. 1B is a perspective interior view of one embodiment of the present invention.

FIG. 2 is an exploded view of the door frame of one embodiment of the present invention.

FIG. 3A is a perspective view of the fixed door panel and sliding door panel of one embodiment of the present invention.

FIG. 3B is a perspective view of the sliding screen panel of one embodiment of the present invention.

FIG. 4 is a cut-off top view of the sliding door system of one embodiment of the present invention showing the positions of the fixed door panel and sliding door panel in the sliding door system and the interior sliding screen panel track.

FIG. 5A is an exploded partial side view of the bottom sealing block and the bottom portion of the door frame of one embodiment of the present invention.

FIG. 5B is a partial side view of the bottom portion of the door frame of FIG. 8A, showing the connection between the bottom sealing block with the bottom portion of the door frame.

FIG. 5C is a partial side view of the bottom portion of the door frame of FIG. 2, with the sliding door panel installed.

FIG. 6 is a partial exterior view of the sliding door system of one embodiment of the present invention, showing the bottom sealing block and the sill track block installed on the bottom portion of the door frame.

FIG. 7A is an exploded partial side view of a bottom portion of the fixed door panel and the bottom portion of the door frame shown in FIG. 5A.

FIG. 7B is a partial side view of the bottom portion of the door frame of FIG. 7A, showing the connection between the fixed door panel with the bottom portion of the door frame.

FIG. 8A is an exploded partial side view of the top sealing block and the top portion of the door frame of one embodiment of the present invention.

FIG. 8B is a partial side view of the top portion of the door frame of FIG. 8A, showing the connection between the top sealing block with the top portion of the door frame.

FIG. 8C is a partial side view of the top portion of the door frame shown in FIG. 2, showing the sealing between the top portion of the sliding door panel and the top sealing block, and the structure and position of the top sliding screen panel track.

FIG. 9A is an exploded partial side view of the top portion of the fixed door panel and the top portion of the door frame of the embodiment shown in FIG. 8A.

FIG. 9B is a partial side view of the top portion of the door frame of FIG. 9A, showing the connection between the top portion of the fixed door panel with the top portion of the door frame.

FIG. 10 is a partial side view of the sliding door system of a further embodiment of the present invention, showing the sliding screen panel installed at the interior side.

FIG. 11 is a perspective view of the removable rail.

FIG. 12 is a perspective view of the bottom side section of the bottom portion of the door frame showing the rail slot.

FIG. 12A is a side view of the bottom side section of door frame shown in FIG. 12.

FIG. 12B is a perspective view of the bottom side section of FIG. 12 with the removable rail installed inside the rail slot.

FIG. 13 is a partial side view of the sliding door system of an alternative embodiment shown in FIG. 12, which has a top removable screen panel track.

FIG. 14 is a partial side view of a screen door system of another embodiment of the present invention, which has both top and bottom removable screen panel tracks at the exterior side of the door.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

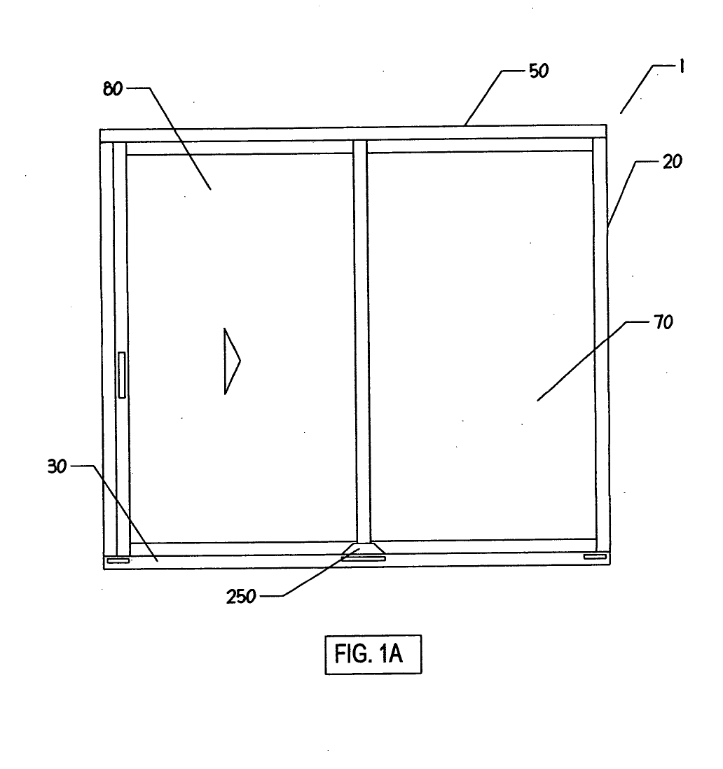

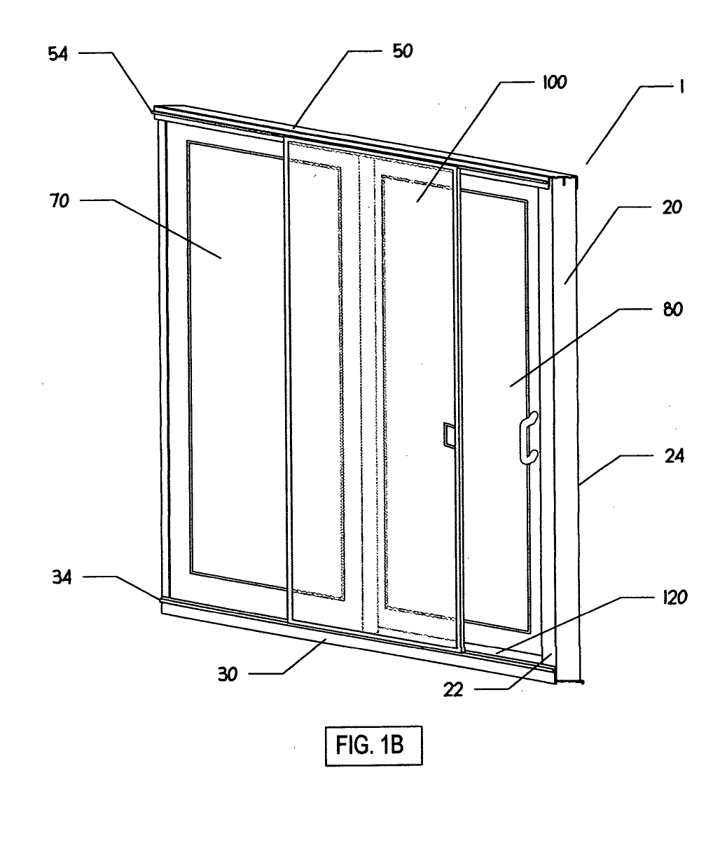

In one embodiment, the present invention provides a sliding glass door system 1. FIG. 1A shows a schematic external view of the sliding glass door system 1 of one embodiment of the present invention. The sliding glass door system comprises a door frame 20, one or more fixed door panel 70 positioned at the interior side of the door frame 20, a sliding door panel 80 positioned at the exterior side of the door frame 20, and a sliding screen panel 100 positioned at the most interior of the door frame 20. FIG. 1B shows an interior view of the sliding glass door system 1, with the sliding screen panel 100 at a partial opening position.

The sliding glass door system of the present invention can be two, three or four panel door systems. In a two panel door system, there is one fixed door panel 70 and one sliding door panel 80. In a three panel door system, there are two fixed door panels 70, one on each side of the door, and one sliding door panel 80 between the fixed door panels. In a four panel door system, there are two fixed door panels 70, one on each side of the door, and two sliding door panels 80 between the fixed door panels. Regardless numbers of panels, the positions of the fixed door panel, sliding door panel and the sliding screen panel in relation to the interior and exterior of the door frame are the same.

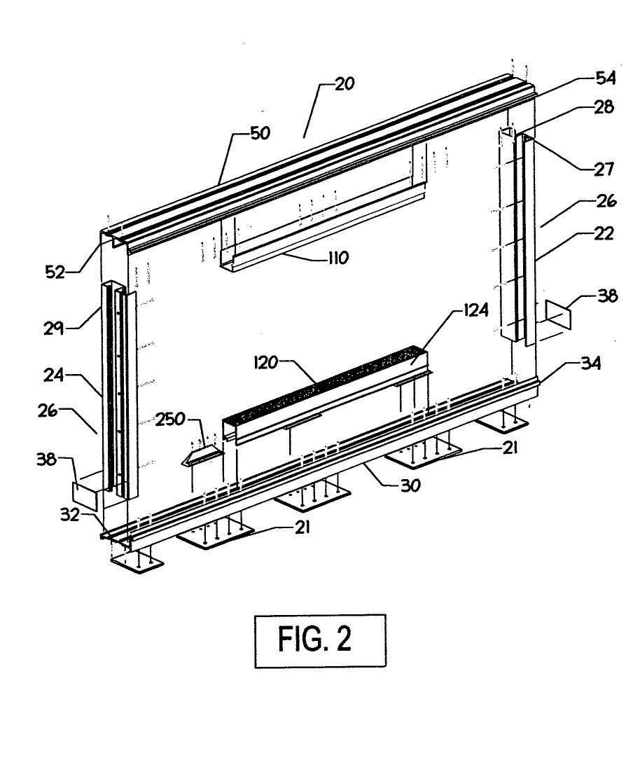

FIG. 2 shows a door frame of a four panel door system. The door frame 20 includes a sliding door panel roller track 32 extending along the bottom portion 30, a sliding door panel sliding track 52 extending along a top portion 50, and a pair of sliding screen panel tracks 34 and 54 extending along the bottom portion 30 and the top portion 50, respectively. The sliding door panel roller track 32 and sliding track 52 are positioned at an exterior side 24 of the door frame 20, and sliding screen panel tracks 34 and 54 are positioned at the most interior of the door frame 20.

The door frame 20 is mounted to the structure opening of the wall by mounting screws. As shown in FIG. 2, the bottom portion 30 is mounted to the floor through multiple mounting panels 21. The mounting screws are positioned along the bottom portion 30 near the interior side of the door frame 20. Upon installation, the bottom of the fixed door panel 70 is positioned on top of the mounting screws on one side of the door frame (or both sides for a three or four panel door), blocking the mounting screws from being seen by the users. Each of the side portions 26 has an indent portion 27 and a protruding portion 28. The protruding portion 28 is at the exterior side 24 and has a flat surface which is in contact with the side of sliding door panel 80 when it is in a closed position. The indent portion 27 is at the interior side 22 and has a flat base 29 directly in contact with the wall when mounted. The flat base 29 has plurality of mounting holes spaced along the vertical axis of the side portion 27. The side portions 26 are mounted to the structure opening by the mounting screws through the plurality of mounting holes, as shown in FIG. 2. Upon installation, one side of the fixed door panel 70 is inserted into the indent portion 27, blocking the mounting screws from being seen by the users. On the protruding portion 28, no mounting screws are used.

Furthermore, the door frame 20 further includes a pair of side sealing panels 38 attached to the lower end of the peripheral side of the side portions 26, as shown in FIG. 2. It has been found that water tends to leak into the house through the interfaces between the side portions 26 and the structure opening of the wall during severe storm condition because of the wind pressure. The side sealing panels 38 provide sealings at the interfaces, which prevents water entrance from the peripheral sides of the door system. The side sealing panel 38 has a height from about 4 to about 8 inches and a thickness from about 0.02 to about 0.06 inches. The width of the side sealing panel 38 substantially matches the width of the side portion 26 of the door frame. In one preferred embodiment, the side sealing panel 38 has a height of about 6 inches, a width of about 4.4 inches, and a thickness of about 0.04 inch. Preferably, the side sealing panels are sealed on to the peripheral side of the side portions 26 by a sealing material, such as silicone.

The top portion 50, bottom portion 30 and the side portions 26 are mounted together by mounting screws, as shown in FIG. 2. All the mounting screws are arranged at the locations which are not exposed to the users view. With this structural design, no mounting screws are in the view of users, which provides a clean and aesthetic appearance of the door frame.

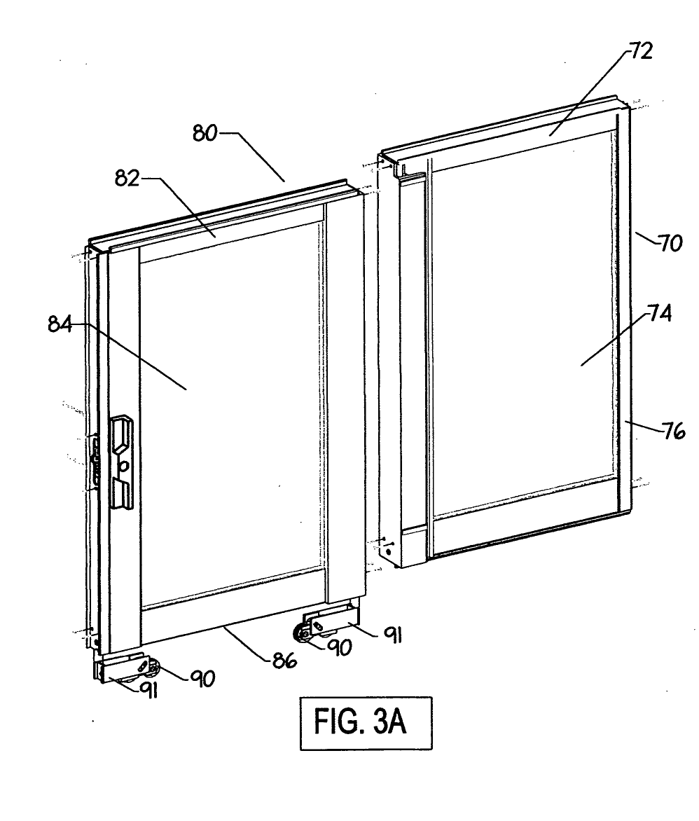

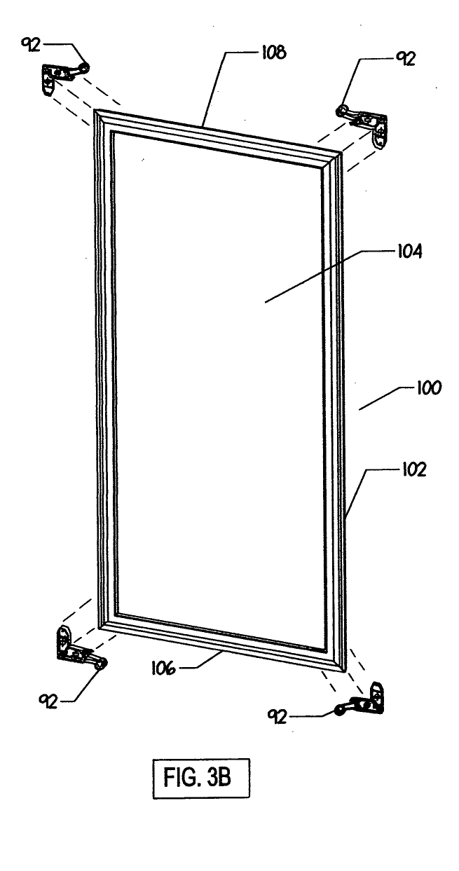

FIG. 3A shows the exterior view of the fixed door panel 70 and the sliding door panel 80. The fixed door panel 70 includes a fixed door sash 72, and a glass panel 74 carried in the fixed door sash 72. The fixed door panel 70 is positioned at the interior side 22 of the door frame 20, with its external side 76 adjacent to the roller track 32 and its internal side 78 facing the inside of the house. The fixed door frame 70 is connected to the door frame 20 by anchoring means at the bottom of the fixed door panel 70, as described in detail hereinafter. Furthermore, the fixed door panel 70 has a bottom sealing bracket 73 on the internal side 78 along the bottom portion of the fixed door sash 72; and an internal top sealing bracket 75 and an external top sealing bracket 77 along the top portion of the fixed door sash 72 for providing air sealing of the door system, which are described in detail hereinafter.

As shown in FIG. 3A, the sliding door panel 80 includes a sliding door sash 82 and a glass panel 84 carried in the sliding door sash 82, and rollers 90 which extends outwardly from a bottom 86 of the sliding door sash 82 and engages the roller track 32 at the bottom portion 30 of the door frame 20. In one embodiment, there are a total of four rollers 90 in two pairs. Each pair is mounted on a roller jacket 91. On the internal side 88 the sliding door panel 80 has a pair of sealing brackets 83 along the top and bottom portions of the sliding door sash 82 for providing air sealing of the door system, which are described in detail hereinafter.

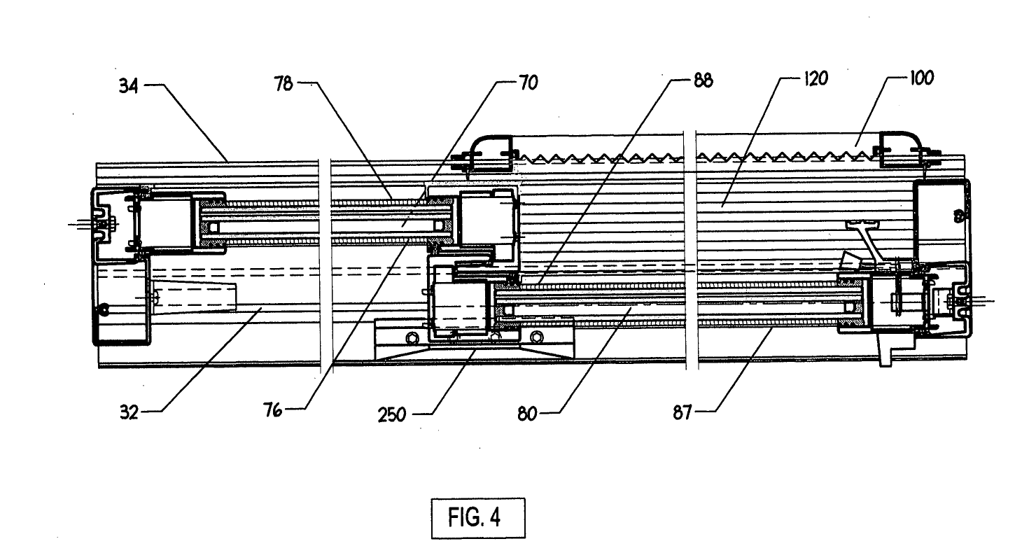

The sliding door panel 80 slidably positions between the sliding door panel roller track 32 and the sliding door panel sliding track 52 of the door frame 20. It slides along the tracks 32 and 52, at the external side 76 of the fixed door panel 70, as shown in FIG. 4.

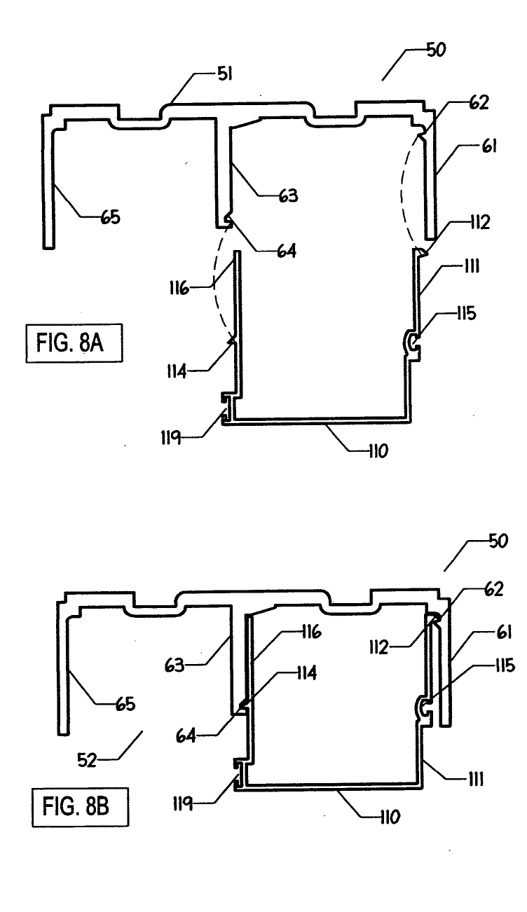

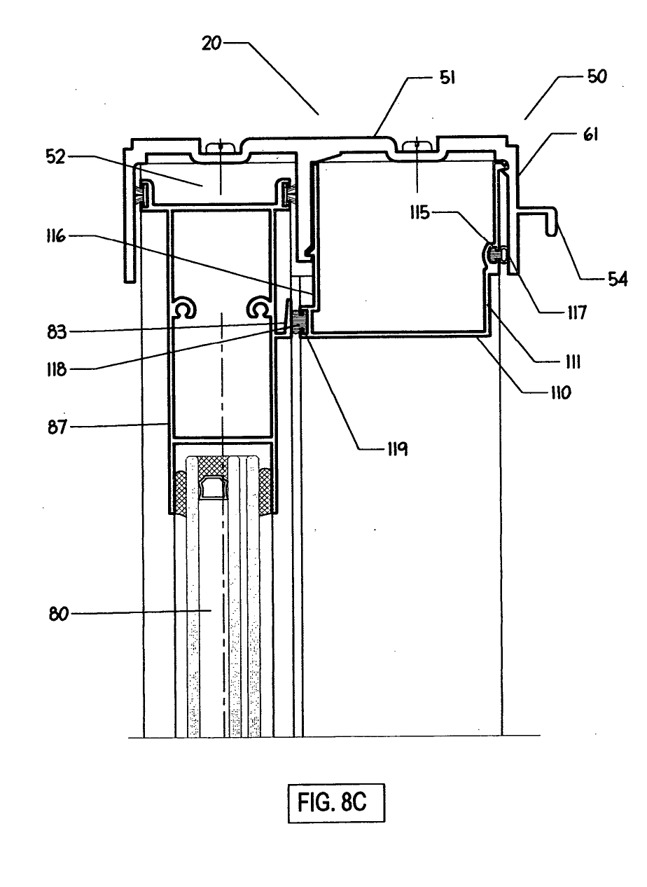

As shown in FIG. 3B, the sliding screen panel 100 includes a sliding screen sash 102 and a screen panel 104 carried in the sliding screen sash 102, and rollers 92 at a bottom 106 and a top 108 of the sliding screen sash 102, which engage the bottom sliding screen panel track 34 and the top sliding screen panel track 54. The sliding screen panel 100 slides along the sliding screen panel tracks 34 and 54, at the internal side 78 of the fixed door panel 70, as shown in FIG. 4. FIG. 8C shows the structure and the position of the top sliding screen panel track 54 of the door frame 20 in one embodiment of the present invention. The bottom sliding screen panel track 34 can have the same structure.

Different from the traditional sliding door system, the interior sliding screen panel of the present invention will be not be deformed or blown away by wind because it is positioned most interior of the door assembly. Furthermore, under a normal use condition, the interior screen panel does not collect dust when it is not in use. Moreover, with the interior screen panel the exterior of the sliding glass door has a complete glass look, which provides an aesthetic appearance for a high rise building.

As shown in FIG. 2, the door frame 20 further includes a bottom sealing block 120 and a top sealing block 110, which are adjacent to the sliding door panel tracks 32 and 52, respectively, for providing sealing between the sliding door sash 82 and the sealing blocks 110 and 120 to prevent entrance of wind and water under storm weather condition. For a two panel door system, the sealing blocks 110 and 120 are between the fixed door panel 70 and the opposing side of the door frame 20. For a three panel or four panel door systems, the sealing blocks are between two fixed door panels 70.

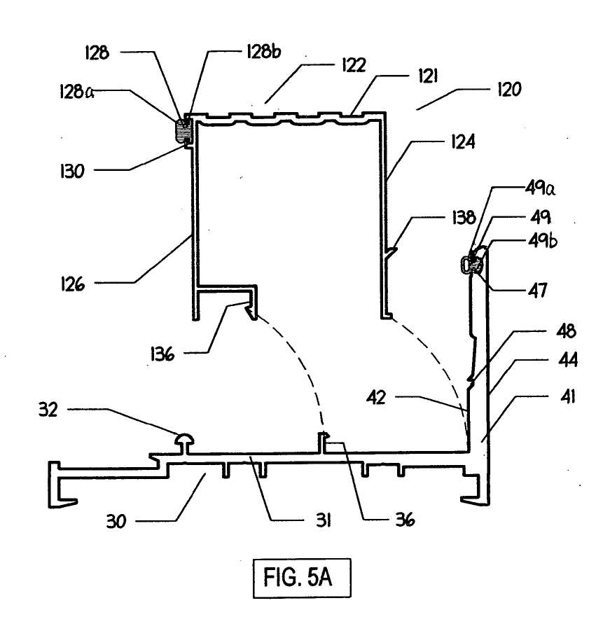

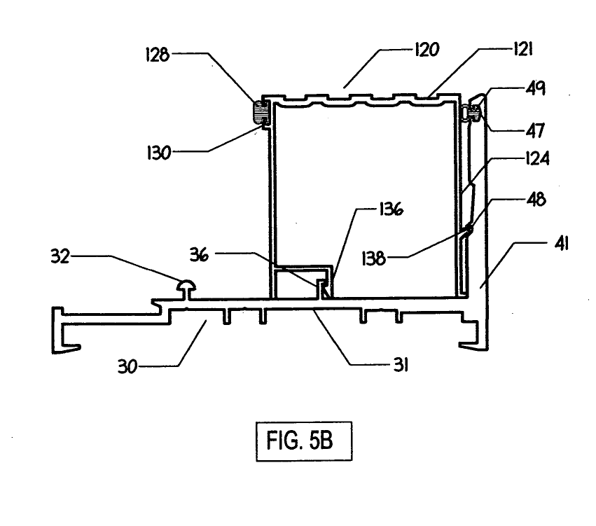

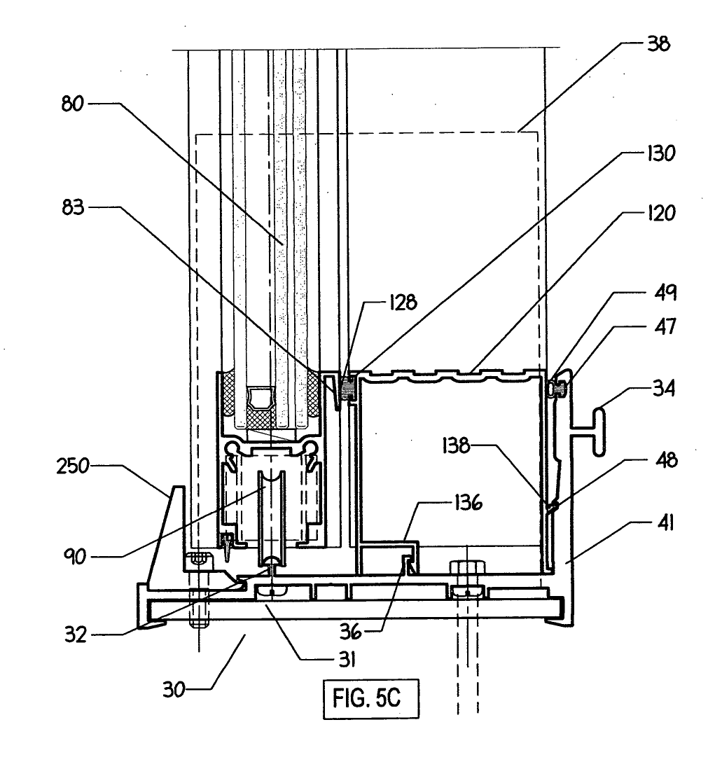

Now referring to FIGS. 5A and 5B, which show the detail structures of the bottom portion of the door frame and the bottom sealing block 120 of the door frame 20 shown in FIG. 2, without the bottom sliding screen panel track 34. As shown, the bottom portion 30 of the door frame 20 has a bottom base section 31 connected perpendicularly to a bottom side section 41. The bottom portion 30 has a first and a second bottom frame anchor means 36 and 48 thereon, respectively. In one embodiment as shown in FIG. 5A, the first bottom frame anchor means 36 is a base anchor, and the second bottom frame anchor means 48 is a side anchor slot on the inner side 42 of the bottom side section 41.

Furthermore, near the top of the inner side 42, there is a bottom frame sealing rim slot 47. A resilient bottom frame sealing rim 49 is inserted into the rim slot 47. The resilient sealing rim can be made of rubber or other suitable materials. In one embodiment, the sealing rim 49 is made of a thin rubber sheet which is folded, with the edge portions mounted inside the rim slot 47. The folded portion of the rubber sheet protrudes from the bottom side section 41 and forms the resilient sealing rim 49. In a preferred embodiment as shown in FIGS. 5A and 5B, the resilient sealing rim 49 is a pre-manufactured gasket having an anchoring base 49b to be mounted inside the rim slot 47, and a resilient rim head 49a which protrudes from the inner side 42 of the bottom side section 41.

As shown, the bottom sealing block 120 has a rectangular shape with a top 122, an internal wall 124, and an external wall 126. The bottom sealing block 120 has a first and a second bottom block anchor means 136 and 138, which are complementary to the first and second bottom frame anchor means 36 and 48, respectively, of the door frame. In one embodiment shown in FIGS. 5A and 5B, the a first bottom block anchor means 136 is a foot anchor extending from the inside of the external wall 126, and the second bottom block anchor means 138 is a side anchor protruding from the internal wall 124.

Furthermore, near the top of the external wall 126, there is a bottom block sealing rim slot 130. A resilient block sealing rim 128 is inserted into the rim slot 130. In one embodiment, the sealing rim 128 is made of a thin rubber sheet which is folded, with the edge portions mounted inside the rim slot 130. The folded portion of the rubber sheet protrudes from the external wall 126 and forms the resilient sealing rim 128. In a preferred embodiment as shown in FIGS. 5A and 5B, the resilient sealing rim 128 is a pre-manufactured gasket having an anchoring base 128b to be mounted inside the rim slot 130, and a resilient rim head 128a which protrudes from the external wall 126. Because of frequent contacts with the sliding door panel 80, the resilient rim head 128a is in a solid form for durability.

At the installation, the bottom sealing block 120 is snapped on to the bottom portion 30 of the door frame. Once it is snapped on, the foot anchor 136 and side anchor 138 of the bottom sealing block 120 interlock with the base anchor 36 and the side anchor slot 48 of the bottom portion 30 of the door frame, thereby the bottom sealing block 120 is firmly attached to the door frame. It should be understood that various other anchoring structures and mechanisms can also be utilized for interlocking the bottom sealing block 120 with the bottom portion 30 of the door frame. Preferably, the bottom sealing block 120 has a height from about 2.5 to about 4.0 inches, which forms a physical block to the water entrance in case that the outside floor is flooded. Additionally, the bottom sealing block 120 has a plurality of grooves 121 on the top 120 to provide a non-slippery walking surface.

As shown in FIG. 5B, upon installation the internal wall 124 of the bottom sealing block 120 is in direct contact with the bottom frame sealing rim 49, which provides a sealing between the bottom sealing block 120 and the side section 41 of the door frame. Alternatively, such a sealing can also be provided with a reversed structure. More specifically, the sealing rim slot 47 and sealing rim 49 can be on the internal wall 124, which provides a sealing contact with the inner side of the bottom side section 41. Such a structural arrangement is shown hereinafter in FIG. 8C.

As shown in FIG. 5C, upon installation of the sliding door panel on the door frame, the bottom block sealing rim 128 is in direct contact with the sealing bracket 83 of the sliding door panel 80. As shown, the sealing bracket 83 protrudes from the bottom portion of the sliding door sash 82, wherein the planner surface is in contact with the protruding bottom block sealing rim 128 along the entire width of the sliding door panel 80 and the bottom sealing block 120. Therefore, when the sliding door panel 80 is in a closed position, the air sealing provided by the sealing bracket 83 and the sealing rim 128 prevents the entrance of wind and water from outside of the door system under severe storm conditions.

Additionally, in the embodiment shown in FIG. 5C, the bottom portion 30 of the door frame 20 has the bottom sliding screen panel track 34 extending from the outer side 44 (which faces the interior of the house) of the bottom side section 41. It is apparent that whether the bottom side section 41 includes the bottom sliding screen panel track 34 or not, the above-described interlocking mechanisms and sealing mechanisms between the door frame and the bottom sealing block 120 can be the same.

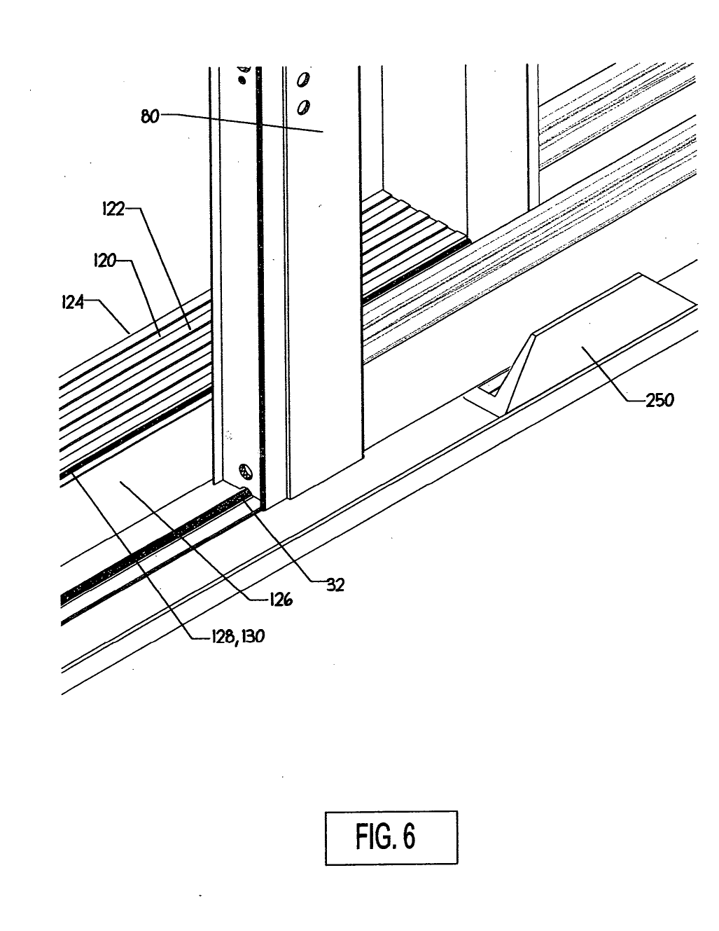

FIG. 6 further illustrates a perspective exterior view of the bottom sealing block 120 in an installed door system 1. Furthermore, the door frame 20 further comprises a sill track block 250 attached to the base portion 31, external of the sliding door panel roller track 32. The sill track block 250 is positioned along a vertical fixed door sash which towards the center of the door frame. When the sliding door panel 80 is in a closed position, one corner of the sliding door panel 80 is behind the sill track block 250. During a hurricane, when the direction of the wind is from inside of the sliding door, for example, when the windows on the opposite side of the house are broken, which is a very common situation during hurricanes, the pressure generated at the inside of the sliding door system can lift the sliding door panel 80 off the sliding door panel roller track 32 and blow the sliding door panel 80 out of the door frame 20. With the sill track block 250, the sliding door panel 80 can be locked inside the door frame 20 in the presence of such strong wind pressure. The door system 1 can have more than one sill track block 250. For a four panel door system, there can be three sill track blocks 250, one for each meeting point of two door panels, i.e., at the meeting point of two sliding door panels, and at the two meeting points of two sliding door panels with two fixed door panels.

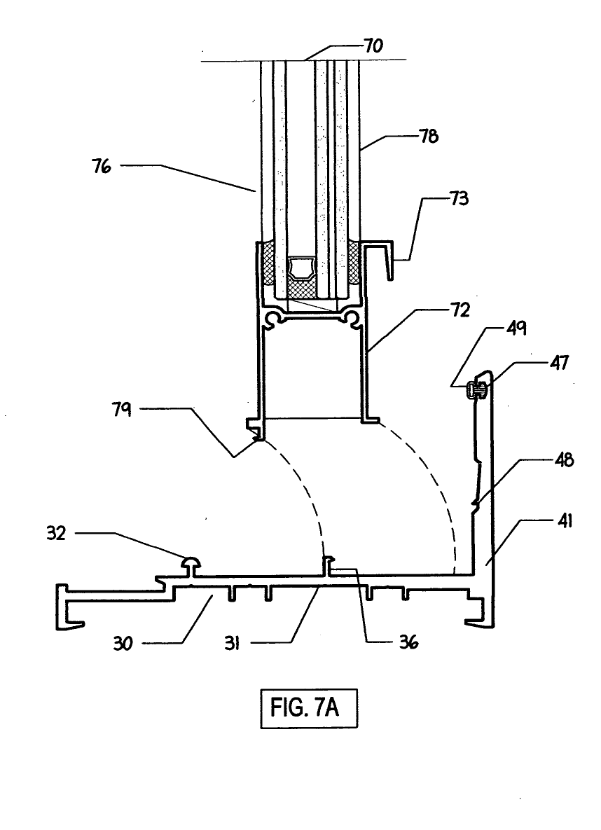

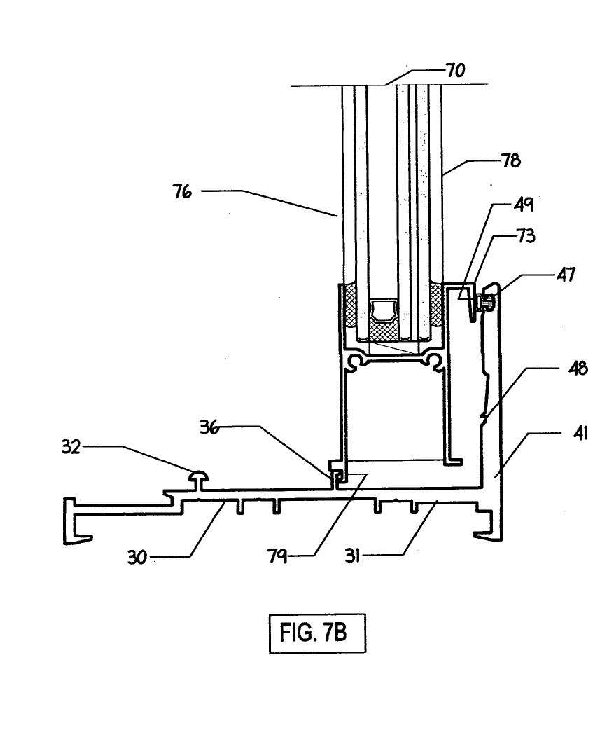

Now referring to FIGS. 7A and 7B, which show the detail structures of the bottom portion of the fixed door panel 70 and its connection with the door frame. As shown, the fixed door panel 70 has a bottom anchoring means 79 underneath the bottom portion of the fixed door sash 72, which is complementary to the base anchor 36 of the door frame. Upon installation, the bottom anchoring means 79 interlocks with the base anchor 36. Furthermore, the fixed door panel 70 has a bottom fixed door sealing bracket 73 protruding from the bottom portion of the fixed door sash 72 on the internal side 78. Preferably, the bottom fixed door sealing bracket 73 extends horizontally along the entire width of the fixed door panel. As shown, upon installation the planner surface of the bracket 73 is in direct contact with the bottom frame sealing rim 49, which provides a sealing between the fixed door panel and the bottom side section of the door frame. Again, such a sealing can be provided with a reverse structure, as described previously with the bottom sealing block.

FIGS. 8A to 8C illustrate the detail structures of the top sealing block 110 and the top portion of the door frame 20, with and without the top sliding screen panel track 54. As shown, the top portion 50 of the door frame has a top base section 51 connected perpendicularly to an interior section 61, a middle section 63 and an external section 65. The top portion 50 has a first top frame anchor means 62 and a second top frame anchor means 64 thereon. In the embodiment shown, the first top frame anchor means 62 is a side anchor on the internal section 62, and the second top frame anchor means 64 is a side anchor slot on the middle section 63.

The top sealing block 110 has a similar structure to the bottom sealing block 120, however with a substantially shorter height than the height of the bottom sealing block 120, since there is no requirement of blocking flooding water at the top of the door. As shown, the top sealing block 110 has a first top block anchor means 112 complementary to the first top frame anchor means 62, and a second top block anchor means 114 complementary to the second top frame anchor means 64, respectively. As shown, the anchor structures of the top sealing block 110 are different from those of the bottom sealing block 120, which demonstrates that different anchoring structures and mechanisms can be utilized for the interlocking the sealing blocks with the door frame.

Furthermore, the top sealing block 110 has two top sealing rim slots 115 and 119, one on the internal wall 111 and one on the external wall 116. A first resilient top block sealing rim 118, as shown in FIG. 8C, is inserted into the rim slot 119. Preferably, the top block sealing rim 118 has the material and structure of the bottom block sealing rim 128, therefore, the same part can be used for both top and bottom sealing blocks. A second resilient top block sealing rim 117, as shown in FIG. 8C, is inserted into the rim slot 115. The same structure and material used for the bottom frame sealing rim 49 can be used for the sealing rim 117.

Similar to the bottom sealing block 120, the top sealing block 110 is snapped on to the top portion of the door frame. Once it is snapped on as shown in FIG. 8B, the first anchor 112 and the second anchor 114 of the top sealing block 110 interlock with the side anchor 62 and the side anchor slot 64 of the top portion 50 of the door frame, thereby the bottom sealing block 110 is firmly attached to the door frame. It is noted that the middle section 63 and the external section 65 form the sliding door panel sliding track 52, which is more apparent in FIG. 8C.

FIG. 8C shows the top portion of the door frame with the sliding door panel 80 installed within. As shown, the first top block sealing rim 118 is in direct contact with the sealing bracket 83 of the sliding door panel 80, same as that described previously with the bottom sealing block 120. Therefore, when the sliding door panel 80 is in a closed position, the air sealing forms along both top and bottom portion of the sliding door panel.

On the other hand, the second top block sealing rim 117 is in direct contact with the internal section 61 of the door frame to provide an additional air sealing. Alternatively, such a sealing can also be provided by a reverse structure, as previously shown with the bottom frame sealing rim 49, which is attached to the door frame instead of the sealing block.

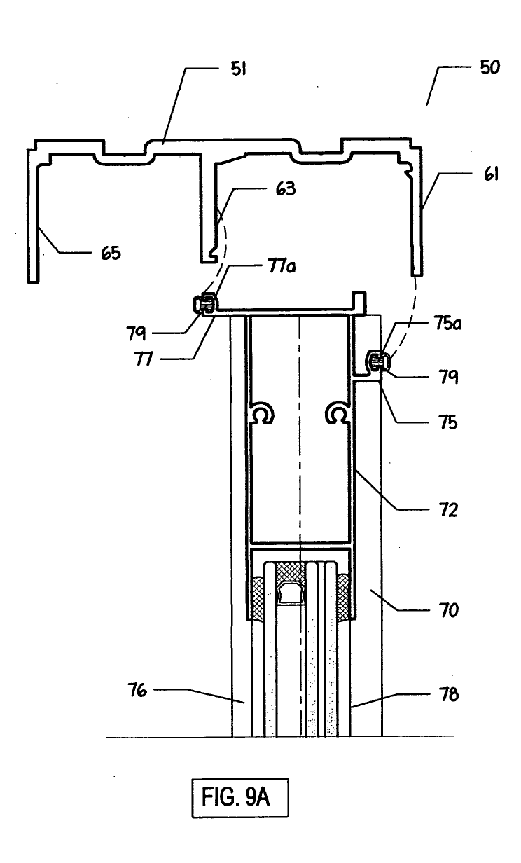

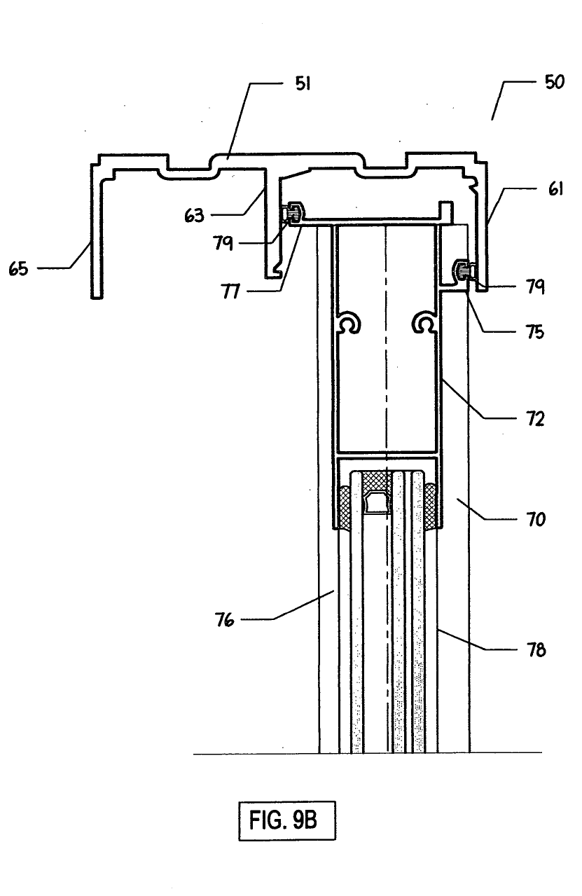

FIGS. 9A and 9B show the sealing mechanisms between the fixed door panel 70 and the top portion 50 of the door frame. As shown in FIG. 9A, the fixed door panel 70 has two top sealing brackets 75 and 77. Instead of the plane planner surface of the bottom sealing bracket 73, each of the top sealing brackets 75 and 77 has a sealing rim slot, as shown as 75a and 77a, respectively. A top sealing rim 79 is inserted into the sealing rim slots 75a and 77a. Preferably, the structure and the material of the sealing rim 79 is the same as the bottom frame sealing rim 49. Upon installation, as shown in FIG. 9B, the top sealing rims 79 of the top sealing brackets 75 and 77 are in direct contact with the internal section 61 and the middle section 63 of the top portion 50 of the door frame, which provide air sealing along the top portion of the fixed door panel 70. Alternatively, such a sealing can be provided by a reverse structure. More specifically, the top sealing rims 79 can be attached to the internal section 61 and the middle section 63 of the top portion 50 of the door frame, as previously described with the bottom side section 41 of the door frame.

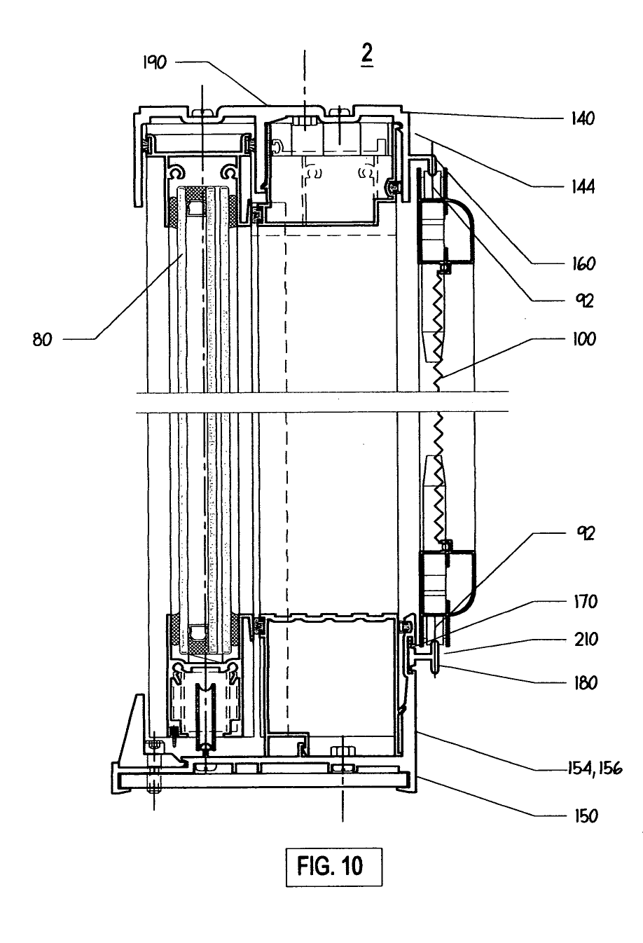

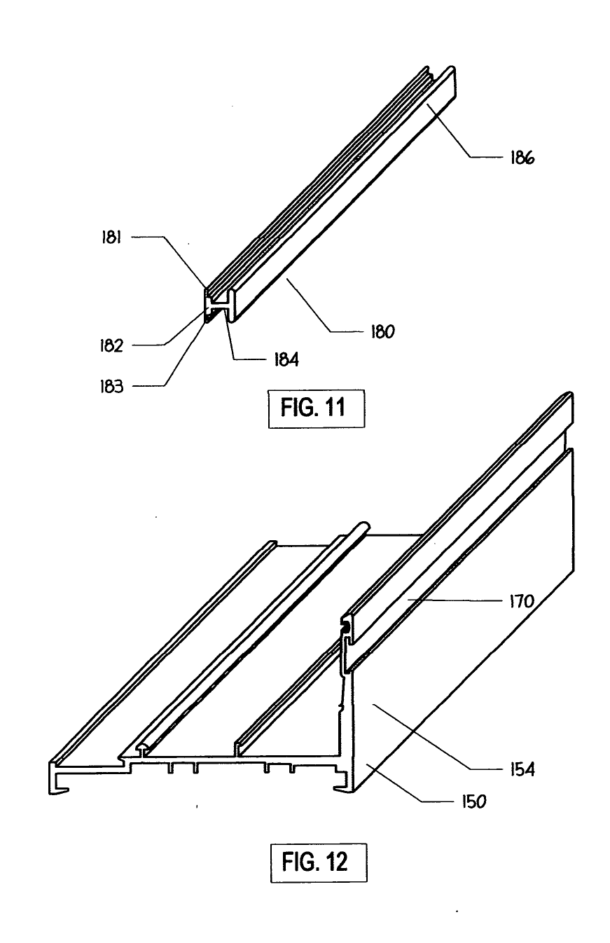

In another embodiment, the present invention provides a sliding glass door system which has a removable screen panel track. As shown in FIG. 10, the sliding glass door system 2 has a door frame 140 which has a fixed top sliding screen panel track 160 and a removable bottom sliding screen panel track 210 at the interior side 144 of the door frame. The top sliding screen panel track 160 has the same structure as that of top sliding screen panel track 54 of the sliding door system 1 described above. As shown in FIGS. 10-12B, the bottom portion 150 has a rail slot 170 on the outer side 156 of the bottom side section 154, extending along the bottom portion 150. A removable rail 180 removably attached to the rail slot 170, which forms the bottom sliding screen panel track 210. It is noted that the outer side 156 of the bottom side section 154 is at the interior side of the sliding door system.

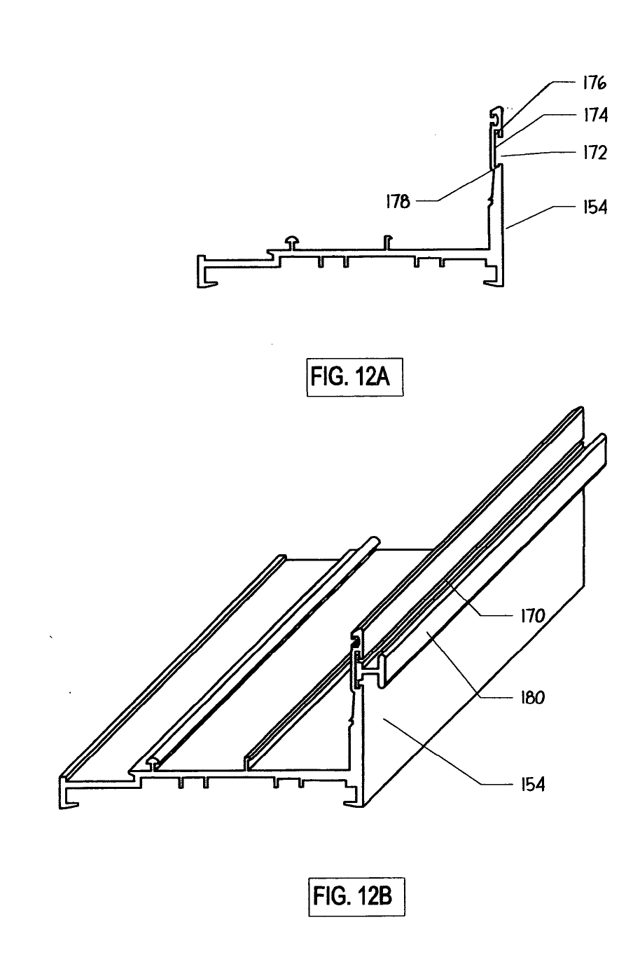

The rail slot 170 is a receiving means for the removable rail 180. The interface portions of the rail slot 170 and the removable rail 180 are complementary to each other for mutual engagement and interlocking. In one embodiment as shown in FIGS. 12-12B, the rail slot 170 has a front opening 172, a back wall 174, an upper recess 176, and a lower recess 178. The removable bottom rail 180 has a T-shape interface portion 182. One part of the interface portion 182 defines the track bottom 184 which is connected to a railing panel 186. When the sliding screen panel is to be installed, the removable rail 180 can be attached to the rail slot 170 through the front opening 172 by first inserting top edge 181 of the interface portion 182 into the upper recess 176, then pushing the rail 180 to the back wall 172, then settling the bottom edge 183 of the interface portion 182 on the lower recess 178. With this attachment, the removable rail 180 is locked into the rail slot 170, which forms stable bottom sliding screen panel track 210. The sliding screen panel 100 can then be placed on top of the railing panel 186, and the roller 92 engages with the top edge of the railing panel 186. The attachment of the removable rail 180 to the rail slot 170 can be done after the installation of the sliding door system 2 is completed. Alternatively, the removable rail 180 can also be slidably inserted into the rail slot 170 from the side, prior to the door frame 140 is installed.

If the user desires, the sliding screen panel can be removed. In this case, the sliding screen panel is removed from the bottom sliding screen panel track 210, and the removable rail 180 can be detached from the rail slot 170 by lifting the rail 180 up to have the top edge 181 of the interface portion 182 against the upper recess 176, pulling the bottom edge 183 of the interface portion 182 out of the front opening 172 first, then remove the top edge 181 out from the rail slot 170.

It should be understood that other complementary structures between the rail slot and the removable rail can also be used for the purpose of the present invention to removably attach the removable rail to the rail slot. Furthermore, other rail receiving means for attaching the removable rail to the door frame can also be utilized. For example, there can be multiple openings along the bottom side section 154 for mounting the removable rail onto the bottom side section 154 by bolts and nuts.

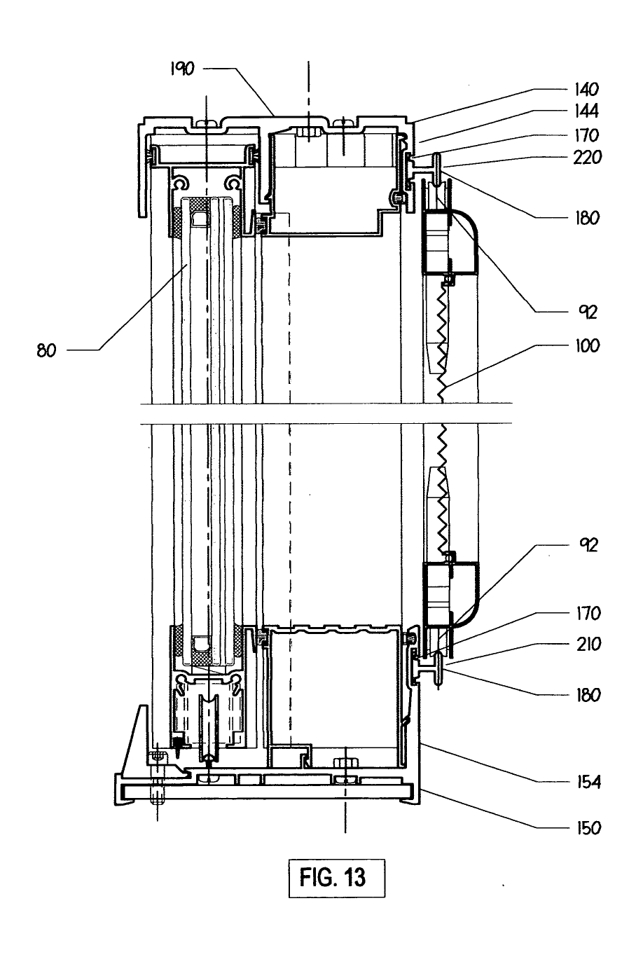

In a further embodiment as shown in FIG. 13, the door frame 140 can also have a removable screen panel track 220 on the top portion 190 of the door frame. The removable top sliding screen panel track 220 is formed by the rail slot 170 and the removable rail 180 described above. The installation of the removable rail 180 into the rail slot 170 is the same as that described for the removable bottom sliding screen panel track 210. In this case, the bottom edge of the railing panel 186 engages with the roller 92 of the sliding screen panel 100.

It is noted that in the door frame 140 the structures and functions of other parts of the door frame other than the side sections are the same as those described previously in door frame 20. Furthermore, the structures and functions of other components of the sliding door system 2 are the same as those described previously in the sliding glass door system 1.

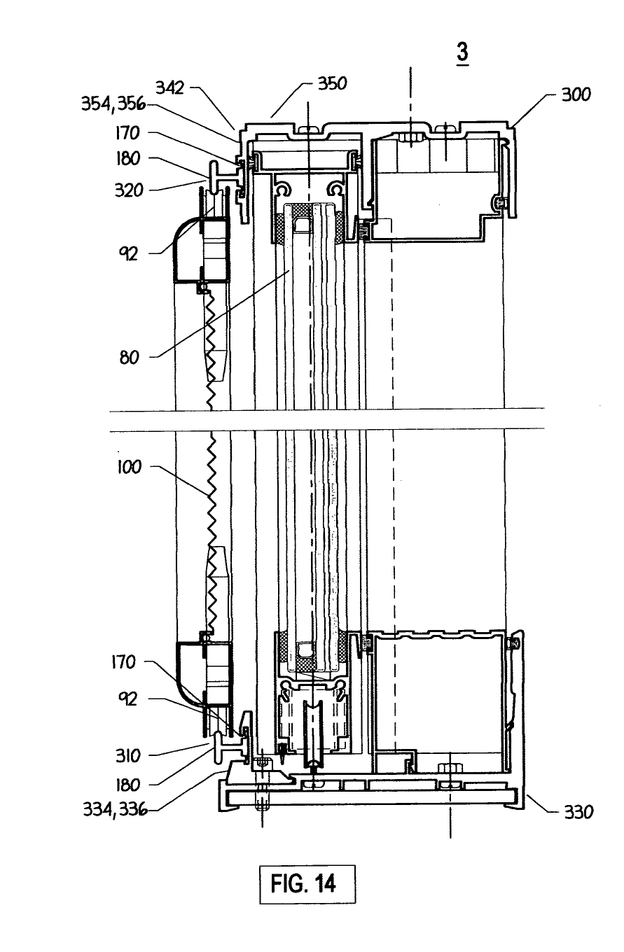

Additionally, the removable sliding screen panel track can also be used at the exterior side of a sliding door system. In another embodiment as shown in FIG. 14, the sliding glass door system 3 has a door frame 300 which has removable bottom and top sliding screen panel tracks 310 and 320, respectively, at the exterior side 342 of the door frame. As shown, one rail slot 170 is on the outer side 356 of the top side section 354 with a removable rail 180 removably attached to the rail slot 170, as described previously in the sliding door system 2. In this embodiment, the bottom portion 330 has a bottom side section 334 at the exterior side of the door frame, the second rail slot 170 is positioned on the outer side 336 of the bottom side section 334 with a removable rail 180 removably attached to the rail slot 170. The sliding screen panel 100 is installed at the exterior side of the sliding door system 3. It is noted that the outer side 336 of the bottom side section 334 and the outer side 356 of the top side section 354 are at the exterior side of the sliding door system.

The structures and functions of other components of the sliding door system 3 are the same as those described previously in the sliding glass door system 1, except that the sill track block 250 may be incorporated with the bottom side section 334.

Using the sliding glass door system 2 or 3, the user can choose whether to install a screen panel as he or she desires. Different from previously sliding glass doors, the manufacturers of the instant sliding glass door systems can make one design of a door frame to meet different customer needs, which results in direct and indirect manufacturing savings.

It should be understood that the door frames 20, 140 and 300 can be provided as an integral part of the sliding glass door systems 1, 2 and 3, and can also be provided separately from the door panels.

The door frames, the fixed and sliding door sashes, and sliding screen panel sash can be made of metals, such as aluminium, steel, alloy, and other suitable materials, preferably, they are made of aluminium. The glass panel is preferably made of double or triple layers of glass, preferably, laminated glass.

While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents.

1. A sliding glass door system comprising:
(a) a door frame to be positioned in a structure opening, said door frame having a bottom portion, a top portion and two side portions; said bottom portion having a bottom base section connected perpendicularly to a bottom side section at an interior side of said door fame; said top portion having a top base section connected perpendicularly to a top side section at the interior side; wherein said door frame has a first sliding door panel track extending along said bottom base section, a second sliding door panel track extending along said top base section, a top sliding screen panel track protruding from an outer side of said top side section and extending along said top portion; and a rail receiving means on an outer side of said bottom side section and extending along said bottom side section; and
(b) at least one fixed door panel, positioned between said top portion and bottom portion of said door frame, said fixed door panel comprising a fixed door sash and a glass panel carried in said fixed door sash; and
(c) at least one sliding door panel slidably positioned between said sliding door panel tracks; said sliding door panel comprising a sliding door sash and a glass panel carried in said sliding door sash, sliding door rollers extending outwardly from a bottom of said sliding door sash and engaging said first sliding door panel track.

2. The sliding glass door system of claim 1, wherein said door system further comprises:
(d) a removable rail removably attached to said rail receiving means of said door frame to form a bottom sliding screen panel track; and
(e) a sliding screen panel slidably positioned between said top sliding screen panel track and said bottom sliding screen panel track; said sliding screen panel comprising a sliding screen sash and a screen panel carried in said sliding screen sash.

3. The sliding glass door system of claim 2, wherein said rail receiving means is a rail slot extending along said bottom side section.

4. The sliding glass door system of claim 2, wherein said sliding door panel has a pair of sliding door sealing brackets protruding from an internal side of said sliding door sash, extending horizontally along a top and a bottom portion of said sliding door sash; and said sliding glass door system further comprises:
(f) a bottom sealing block and a top sealing block horizontally aligned between said fixed door panel and an opposing side portion of said door frame for a two panel door system, or between two said fixed door panels for a three or four panel door system, and adjacent to said sliding door panel tracks; wherein each of said sealing blocks has a resilient block external sealing rim attached to an external wall of said sealing blocks, extending horizontally along said sealing blocks; wherein said bottom portion of said door frame has a first and a second bottom frame anchor means thereon; said bottom sealing block has a first and a second bottom block anchor means complementary to said first and second bottom frame anchor means, respectively; and said bottom sealing block is connected to said bottom portion of said door frame, by interlocking said first and second bottom block anchor means with said first and second bottom frame anchor means, respectively; and
wherein when said sliding door panel is in a closed position, said sliding door sealing brackets are in direct contacts with said block external sealing rims along said top and bottom sealing blocks to provide air sealing between said sliding door sash and said sealing blocks.

5. The sliding glass door system of claim 4, wherein there is a resilient bottom frame sealing rim attached to an inner side of said bottom side section of said door frame, extending horizontally along said bottom side section; and an internal wall of said bottom sealing block is in direct contact with said bottom frame sealing rim to provide an additional sealing of said door system.

6. The sliding glass door system of claim 4, wherein said fixed door panel further comprises a fixed door panel anchoring means complementary to said first bottom frame anchor means for interlocking said fixed door panel with said bottom portion of said door frame.

7. The sliding glass door system of claim 6, wherein said fixed door panel further comprises a bottom fixed door sealing bracket protruding from an internal side of said fixed door sash, extending horizontally along a bottom portion of said fixed door sash; and wherein said bottom fixed door sealing bracket is in direct contact with said bottom frame sealing rim of said bottom portion of said door frame to provide an additional sealing of said door system.

8. The sliding glass door system of claim 4, wherein said bottom sealing block further comprises a resilient bottom block internal sealing rim attached to an internal wall thereof, extending horizontally along said bottom sealing block; and said bottom block internal sealing rim is in direct contact with said bottom side section of said door frame to provide an additional sealing of said door system.

9. The sliding glass door system of claim 8, wherein said fixed door panel further comprises a bottom fixed door sealing bracket on an internal side of said fixed door sash, extending horizontally along a bottom portion of said fixed door sash, and has a bottom fixed door sealing rim attached to said sealing bracket; wherein said bottom fixed door sealing rim is in direct contact with said bottom side section of said bottom portion of said door frame to provide an additional sealing of said door system.

10. The sliding glass door system of claim 4, wherein said bottom sealing block covers mounting screws on said bottom portion of said door frame.

11. The sliding glass door system of claim 4, wherein said bottom sealing block further comprises a plurality of grooves on a top thereof to provide a non-slippery walking surface.

12. The sliding glass door system of claim 4, wherein said top portion of said door frame has a middle section and an exterior section, both connected perpendicularly to said top base section; and said top portion has a first and a second top frame anchor means thereon.

13. The sliding glass door system of claim 12, wherein said top sealing block has a first and a second top block anchor means complementary to said first and second top frame anchor means, respectively; said top sealing block is connected to said top portion of said door frame, by interlocking said first and second top block anchor means with said first and second top frame anchor means, respectively.

14. The sliding glass door system of claim 13, wherein said top sealing block further comprises a resilient top block internal sealing rim attached to an internal wall thereof, extending horizontally along said top sealing block; and said top block internal sealing rim is in direct contact with an inner side of said interior section of said top portion to provide an additional sealing of said door system.

15. The sliding glass door system of claim 14, wherein said fixed door panel further comprises a first top fixed door sealing bracket on an internal side of said fixed door sash, extending horizontally along a top portion of said fixed door sash, and a first top fixed door sealing rim attached to said top fixed door sealing bracket; wherein said top fixed door sealing rim is in direct contact with said internal section of said top portion of said door frame to provide an additional sealing of said door system.

16. The sliding glass door system of claim 15, wherein said fixed door panel further comprises a second top fixed door sealing bracket on an external side of said fixed door sash, extending horizontally along a top portion of said fixed door sash, and a second top fixed door sealing rim attached to said second top fixed door sealing bracket; wherein said second top fixed door sealing rim is in direct contact with said middle section of said top portion of said door frame to provide an additional sealing of said door system.

17. The sliding glass door system of claim 13, wherein there is a resilient top frame sealing rim attached to an inner side of said interior section of said top portion, extending horizontally along said interior section; and an internal wall of said top sealing block is in direct contact with said top frame sealing rim to provide an additional sealing of said door system.

18. The sliding glass door system of claim 17, wherein said fixed door panel further comprises a top fixed door sealing bracket on an internal side of said fixed door sash, extending horizontally along a top portion of said fixed door sash; and wherein said top fixed door sealing bracket is in direct contact with said top frame sealing rim of said top portion of said door frame to provide an additional sealing of said door system.

19. The sliding glass door system of claim 13, wherein said top sealing block covers mounting screws on said top portion of said door frame.

20. The sliding glass door system of claim 13, wherein each of side portions of said door frame has an indent portion and a protruding portion, said indent portion being at said interior side and said protruding portion being at said exterior side of said door frame; and said each side portion is mounted to said structure opening by mounting screws vertically along said indent portion; and wherein upon installation, said fixed door panel is inserted into said indent portion of one side portion, thereby blocking mounting screws from an user's view.

21. The sliding glass door system of claim 20, wherein said door frame further comprises a pair of side sealing plates, each being attached to a lower end of a peripheral side of said each side portion of said door frame.

22. The sliding glass door system of claim 21, wherein said side sealing plates have a height from about 4 to about 8 inches.

23. The sliding glass door system of claim 13 further comprising one or more sill track block, said sill track block being attached to said bottom portion of said door frame external of said first sliding door panel track, and positioned along a vertical fixed door sash which towards a center of said door frame; wherein said sill track block prevents said sliding door panel from being blown out from said door frame by a strong wind.

24. A sliding glass door system having a removable screen panel track comprising:
(a) a door frame to be positioned in a structure opening, said door frame having a bottom portion, a top portion and two side portions; said bottom portion having a bottom base section connected perpendicularly to a bottom side section;
said top portion having a top base section connected perpendicularly to a top side section; wherein said door frame has a first sliding door panel track extending along said bottom base section, a second sliding door panel track extending along said top base section; a top sliding screen panel track extending along said top side section; a bottom rail receiving means on and extending along said bottom side section; and a bottom rail removably attached to said bottom rail receiving means forming a bottom sliding screen panel track;
(b) at least one fixed door panel, positioned between said top portion and bottom portion of said door frame, said fixed door panel comprising a fixed door sash and a glass panel carried in said fixed door sash;
(c) at least one sliding door panel slidably positioned between said sliding door panel tracks; said sliding door panel comprising a sliding door sash and a glass panel carried in said sliding door sash, sliding door rollers extending outwardly from a bottom of said sliding door sash and engaging said first sliding door panel track; and
(d) a sliding screen panel slidably positioned between said top sliding screen panel track and said bottom sliding screen panel track; said sliding screen panel comprising a sliding screen sash and a screen panel carried in said sliding screen sash.

25. The door frame of claim 24, wherein said bottom rail receiving means is a bottom rail slot on an outer side of said bottom side section and extending along said bottom side section.

26. The door frame of claim 24, wherein said top side section has a top rail receiving means on and extending along said top side section; and a top rail removably attached to said top rail receiving means forming said top sliding screen panel track.

27. The door frame of claim 26, wherein said top rail receiving means is a top rail slot on an outer side of said top side section and extending along said top side section.

28. The door frame of claim 24, wherein said bottom side section is at an interior side of said door frame, and said bottom and top sliding screen panel tracks are at said interior side of said door frame.

29. The door frame of claim 24, wherein said bottom side section is at an exterior side of said door frame, and said bottom and top sliding screen panel tracks are at said exterior side of said door frame.

30. The sliding glass door system of claim 24, wherein said sliding door panel has a pair of sliding door sealing brackets protruding from an internal side of said sliding door sash, extending horizontally along a top and a bottom portion of said sliding door sash; and said sliding glass door system further comprises:
a bottom sealing block and a top sealing block horizontally aligned between said fixed door panel and an opposing side portion of said door frame for a two panel door system, or between two said fixed door panels for a three or four panel door system, and adjacent to said sliding door panel tracks; wherein each of said sealing blocks has a resilient block external sealing rim attached to an external wall of said sealing blocks, extending horizontally along said sealing blocks;
wherein said bottom portion of said door frame has a first and a second bottom frame anchor means thereon; said bottom sealing block has a first and a second bottom block anchor means complementary to said first and second bottom frame anchor means, respectively; and said bottom sealing block is connected to said bottom portion of said door frame, by interlocking said first and second bottom block anchor means with said first and second bottom frame anchor means, respectively; and
wherein when said sliding door panel is in a closed position, said sliding door sealing brackets are in direct contacts with said block external sealing rims along said top and bottom sealing blocks to provide air sealing between said sliding door sash and said sealing blocks.

31. The sliding glass door system of claim 30, wherein there is a resilient bottom frame sealing rim attached to an inner side of said bottom side section of said door frame, extending horizontally along said bottom side section; and an internal wall of said bottom sealing block is in direct contact with said bottom frame sealing rim to provide an additional sealing of said door system.

32. The sliding glass door system of claim 30, wherein said fixed door panel further comprises a fixed door panel anchoring means complementary to said first bottom frame anchor means for interlocking said fixed door panel with said bottom portion of said door frame.

33. The sliding glass door system of claim 32, wherein said fixed door panel further comprises a bottom fixed door sealing bracket protruding from an internal side of said fixed door sash, extending horizontally along a bottom portion of said fixed door sash; and wherein said bottom fixed door sealing bracket is in direct contact with said bottom frame sealing rim of said bottom portion of said door frame to provide an additional sealing of said door system.

34. The sliding glass door system of claim 30, wherein said bottom sealing block further comprises a resilient bottom block internal sealing rim attached to an internal wall thereof, extending horizontally along said bottom sealing block; and said bottom block internal sealing rim is in direct contact with said bottom side section of said door frame to provide an additional sealing of said door system.

35. The sliding glass door system of claim 34, wherein said fixed door panel further comprises a bottom fixed door sealing bracket on an internal side of said fixed door sash, extending horizontally along a bottom portion of said fixed door sash, and has a bottom fixed door sealing rim attached to said sealing bracket; wherein said bottom fixed door sealing rim is in direct contact with said bottom side section of said bottom portion of said door frame to provide an additional sealing of said door system.

36. The sliding glass door system of claim 30, wherein said bottom sealing block covers mounting screws on said bottom portion of said door frame.

37. The sliding glass door system of claim 30, wherein said bottom sealing block further comprises a plurality of grooves on a top thereof to provide a non-slippery walking surface.

38. The sliding glass door system of claim 30, wherein said top portion of said door frame has a middle section and an exterior section, both connected perpendicularly to said top base section; and said top portion has a first and a second top frame anchor means thereon.

39. The sliding glass door system of claim 38, wherein said top sealing block has a first and a second top block anchor means complementary to said first and second top frame anchor means, respectively; said top sealing block is connected to said top portion of said door frame, by interlocking said first and second top block anchor means with said first and second top frame anchor means, respectively.

40. The sliding glass door system of claim 39, wherein said top sealing block further comprises a resilient top block internal sealing rim attached to an internal wall thereof, extending horizontally along said top sealing block; and said top block internal sealing rim is in direct contact with an inner side of said interior section of said top portion to provide an additional sealing of said door system.

41. The sliding glass door system of claim 40, wherein said fixed door panel further comprises a first top fixed door sealing bracket on an internal side of said fixed door sash, extending horizontally along a top portion of said fixed door sash, and a first top fixed door sealing rim attached to said top fixed door sealing bracket; wherein said top fixed door sealing rim is in direct contact with said internal section of said top portion of said door frame to provide an additional sealing of said door system.

42. The sliding glass door system of claim 41, wherein said fixed door panel further comprises a second top fixed door sealing bracket on an external side of said fixed door sash, extending horizontally along a top portion of said fixed door sash, and a second top fixed door sealing rim attached to said second top fixed door sealing bracket; wherein said second top fixed door sealing rim is in direct contact with said middle section of said top portion of said door frame to provide an additional sealing of said door system.

43. The sliding glass door system of claim 39, wherein there is a resilient top frame sealing rim attached to an inner side of said interior section of said top portion, extending horizontally along said interior section; and an internal wall of said top sealing block is in direct contact with said top frame sealing rim to provide an additional sealing of said door system.

44. The sliding glass door system of claim 43, wherein said fixed door panel further comprises a top fixed door sealing bracket on an internal side of said fixed door sash, extending horizontally along a top portion of said fixed door sash; and wherein said top fixed door sealing bracket is in direct contact with said top frame sealing rim of said top portion of said door frame to provide an additional sealing of said door system.

45. The sliding glass door system of claim 39, wherein said top sealing block covers mounting screws on said top portion of said door frame.

46. The sliding glass door system of claim 39, wherein each of side portions of said door frame has an indent portion and a protruding portion, said indent portion being at said interior side and said protruding portion being at said exterior side of said door frame; and said each side portion is mounted to said structure opening by mounting screws vertically along said indent portion; and wherein upon installation, said fixed door panel is inserted into said indent portion of one side portion, thereby blocking mounting screws from an user's view.

47. The sliding glass door system of claim 46, wherein said door frame further comprises a pair of side sealing plates, each being attached to a lower end of a peripheral side of said each side portion of said door frame.

48. The sliding glass door system of claim 47, wherein said side sealing plates have a height from about 4 to about 8 inches.

49. The sliding glass door system of claim 39 further comprising one or more sill track block, said sill track block being attached to said bottom portion of said door frame external of said first sliding door panel track, and positioned along a vertical fixed door sash which towards a center of said door frame; wherein said sill track block prevents said sliding door panel from being blown out from said door frame by a strong wind.

50. A door frame having a removable screen panel track comprising:
(a) a bottom portion having a bottom base section connected perpendicularly to a bottom side section of said door fame; a first sliding door panel track extending along said bottom base section; a bottom rail receiving means extending along said bottom side section; and a bottom rail removably attached to said bottom rail receiving means forming a bottom sliding screen panel track;
(b) a top portion having a top base section connected perpendicularly to a top side section; a second sliding door panel track extending along said top base section; and a top sliding screen panel track extending along said top side section; and
(c) two side portions.

51. The door frame of claim 50, wherein said bottom rail receiving means is a bottom rail slot extending along said bottom side section.

52. The door frame of claim 51, wherein said bottom rail has an interface portion complementary to said bottom rail slot and being situated within said bottom rail slot.

53. The door frame of claim 50, wherein, said top sliding screen panel track is fixed on to said top side section.

54. The door frame of claim 50, wherein said top side section has a top rail receiving means extending along said top side section; and a top rail removably attached to said top rail receiving means forming said top sliding screen panel track.

55. The door frame of claim 54, wherein said top rail receiving means is a top rail slot extending along said bottom side section.

56. The door frame of claim 55, wherein said top rail has an interface portion complementary to said top rail slot and being situated within said top rail slot.

57. The door frame of claim 50, wherein said bottom side section is at an interior side of said door frame, and said bottom and top sliding screen panel tracks are at said interior side of said door frame.

58. The door frame of claim 50, wherein said bottom side section is at an exterior side of said door frame, and said bottom and top sliding screen panel tracks are at said exterior side of said door frame.
